(19) United States
(12) Patent Application Publication
(10) Pub. No.: US 2019/0134846 A1
(43) Pub. Date: May 9, 2019

(54) METHOD AND DEVICE, IN PARTICULAR FOR APPLYING CLAY TO A SURFACE

(71) Applicant: UDO TARTLER, Lutzelbach/Haingruand (DE)

(72) Inventor: Udo Tartler, Lutzelbach/Haingrund (DE)

(21) Appl. No.: 16/099,760

(22) PCT Filed: May 29, 2017
(86) PCT No.: PCT/EP2017/062867

§ 371 Date: Nov. 8, 2018

(30) Foreign Application Priority Data
May 27, 2016 (DE) 10 2016 109 816.7

(51) Int. Cl. B28B 3/20

(52) U.S. Cl. CPC B28B 3/201; B28B 1/30

(57) ABSTRACT

The invention relates to a method for mechanically treating clay (4), in particular for producing models, the clay (4) being heated by an extruder, extruded and applied to a surface (8), and to a corresponding device for mechanically treating clay (4), in particular for producing models. The invention is characterised in the device comprises an extruder (6) which is designed to heat and extrude clay (4) for applying to a surface (8).

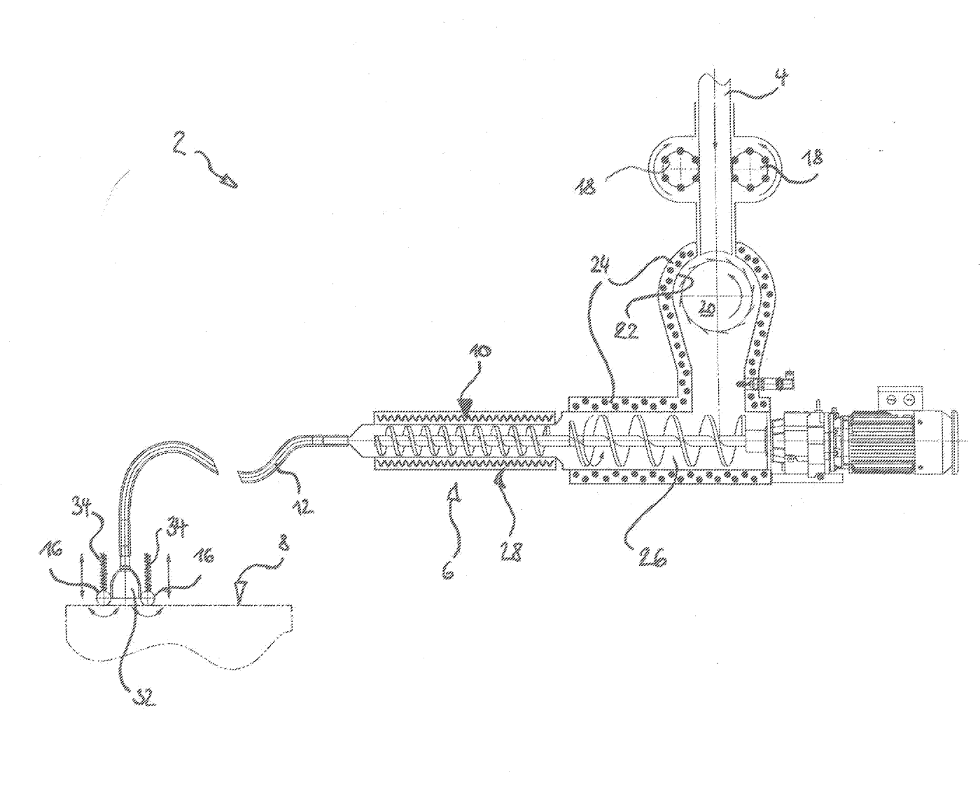

The present invention relates to a method and a device for the mechanical processing of clay or similar materials such as, for example, plasteline, in particular for the production of models.

Clay is a material that is used in particular for model making in automotive design. However, character designers, for example for films, cartoons and video games, industrial designers, artists and architects also use this material to produce models of their three-dimensional designs. It is a further development specifically for this purpose of the well-known plastilin that was developed by Franz Kolb.

Clay is a material that is plastically deformable at certain temperatures and is usually wax based. Sulphur is used as the filler in most variants. Clay usually has a brownish or grey colour, which makes it easy to view a modelled form, in particular firstly for the inspection of this form by the designer during modelling.

For example, prior to the market launch of a new car, the design process for its new bodywork is long and time-consuming: Sketches, drawings and 3D CAD are first of all used. But even today, models of the vehicle are ultimately built, normally in different scales of 1:10 and 1:4 to 1:1. This is due to the fact that only such models allow shapes and proportions to be effectively assessed as a whole and in detail. The shapes and proportions of the clay model can furthermore also be reworked and finished in a fine and detailed manner. The reason for this is that clay can, for example, be milled, planed, carved or sanded with a high dimensional stability at room temperature. However, the subsequent application of material is also possible, whereby the clay is heated by means of a hot-air blower, for example in the area of the planned material application (to temperatures in the two-digit Celsius temperature range). In this temperature range, clay can be plastically deformed and forms a substantially homogeneous bond with the clay material having approximately the same temperature that is additionally applied here. Once cooled, the area that has been supplemented by the applied clay material is dimensionally stable again and can be processed again by means of removal processes. Clay can also be painted using known method steps. It is thus overall possible to produce a model from clay that comes extremely close to or is even identical to the planned product in terms of shape and surface.

For such a model, a wooden or metal frame is normally first of all produced, to which sheets (for example foam sheets) made of, for instance, polyurethane are attached, to which clay can be applied as the described modellable outer layer of the model. As is well known, this application is carried out by hand, with the warmed clay (less than 60° C.) normally being applied using kneading hand movements and being processed using spatula-like tools and blades—namely in the mentioned temperature range of the clay, in which it is plastically deformable and thus also adheres well to the sheets of the frame. During and after this application, provided that the clay has not cooled down completely, the desired surface shape of the clay can also, at least in parts, already be produced by means of plastic shaping or can at least be prepared by means of corresponding contouring.

The object forming the basis for the present invention is to create a method and device for the mechanical processing of clay, in particular for the production of models, which simplify and accelerate model making using clay as the moulding material.

This object is solved by a method having the features of claim 1 and a device having the features of claim 6. Preferred embodiments are specified in the sub-claims.

According to the invention, a method for the mechanical processing of clay (or plastilin or a similar modelling material—hereinafter collectively referred to as clay), in particular for the production of models, is characterised in that the clay is heated, extruded and applied to a surface and preferably also “massaged in” to this surface by means of a heated, temperature-controlled conveying and dosage system, in particular an extruder. According to the invention, a device for the mechanical processing of clay, in particular for the production of models, is accordingly also characterised in that the device comprises an extruder that is configured to heat and extrude clay for application to a surface.

Heating occurs to a temperature in the temperature range in which the used clay can be plastically deformed. This range is normally above room temperature and well below 100° C.—preferably in a range in which the clay can be touched without the risk of burns. Heating in the extruder can take place by means of a precise heating device, if required a heating/cooling device, whereby friction in the extruder must be taken into consideration. Currently known types of clay should never be heated to more than 60° C. A precise temperature control is thus very advantageous for this reason.

Prior to heating in the extruder, the clay (which is normally sold as a rod, strand or bar) is preferably reduced in size, chipped or pelletised. This can also occur discontinuously, separately from the extruder in terms of time and/or space. However, it is also in accordance with the invention to continuously reduce the size of the commercially available, supplied clay rods, for instance by chipping, tearing or cutting, in a corresponding device in a first section of the extruder (cutting drum/cutting device). The clay pieces (pellets, chips, granules) have dimensions preferably in the range of 1 to 20 mm. This reduction in size (also the production of flakes or shavings) facilitates further processing and in particular also supply to and heating in the extruder.

In particular so that the extruded clay can ultimately be applied homogeneously and without cavities in accordance with the invention, the extruder preferably compacts and/or removes air from the clay in a suitably designed screw section. This is particularly advantageous when processing clay that has previously been reduced in size as described above.

According to the invention, the clay can be applied to a surface via a (in particular heatable, temperature-controlled) tube, which is an element of a correspondingly adapted device for applying the extruded clay—such as, for example, with a heatable, temperature-controlled application nozzle that can make it possible to massage in the clay, for instance using heated pressure rollers.

In order to apply the clay to the base as compactly as possible and without air pockets (for instance, initially to the base plates of a frame or to a hard, modelling foam sheet, and then progressively to the already applied clay), the clay can, according to the invention, be pressed onto the surface during application by means of a device comprising pressure rollers.

Further advantages, designs and details of the invention are described in the following in the description of embodiments and with reference to the enclosed figures:

The FIGURE shows a sectional side view of a device according to the invention.

The FIGURE shows a device 2 for the mechanical processing of clay 4, in particular for the production of models. The device comprises an extruder 6 that is configured to heat clay to be applied to a surface 8 by means of an extruder heater 10, and to extrude clay onto the surface 8 via a heated tube 12 and to be able to “massage” the clay into the surface by means of pressure rollers 16.

Before being heated in the extruder 6, the clay 4 is first of all supplied to the remaining device as a rod, strand or bar 4 by means of conveyor rollers 18 that are arranged opposite one another and are driven in opposite directions, is pressed against a grater 20 and is reduced in size and chipped in the grater 20. The commercially available, supplied clay rods 4 are thereby continuously grated by the grating drum 20 at the front end of the clay rod 4 and are further reduced in size along a cylindrical inner wall 22 comprising a water cooling system 24. The water cooling system 24 is an option of the device according to the invention, by means of which the temperature can be adjusted to below room temperature. Should it transpire during operation that it is better for the temperature to be set to above room temperature for reducing the size of and transporting the clay, the water cooling system 24 can also be operated with warm water as a heating system (or can be replaced, for example, with an electric heater). If the ambient temperature proves to be suitable for operation, it is possible to dispense with the device 24.

This production of chips, granules, flakes or shavings facilitates the further processing of the clay 4 and in particular also the supply to the extruder 6 by means of a screw conveyor 26 (that is also cooled and is also driven by an electric motor) as well as the heating in the extruder 6 by the (electric) extruder heater 10 in the extruder casing 28.

The clay 4 is applied to the surface 8 via the heated tube 12 that comprises an application nozzle 32 which is also heated and which, together with the pressure rollers 16, allows the clay to be massaged into the surface 8 (by guiding, pressing and moving the application nozzle 32 over the surface 8). The pressing onto the surface 8 is supported by pressure springs 34 with abutments (not shown).

1. A method for the mechanical processing of clay, in particular for the production of models, wherein the clay is heated, extruded and applied to a surface by an extruder.

2. The method according to claim 1, wherein the clay is previously reduced in size, chipped or pelletised.

3. The method according to claim 1, wherein the clay is compacted and/or air is removed therefrom in the extruder.

4. The method according to claim 1, wherein the clay is applied to a surface via a tube.

5. The method according to claim 1, wherein the clay is pressed onto a surface by means of pressure rollers.

6. A device for the mechanical processing of clay, in particular for the production of models, wherein the device comprises an extruder that is configured for heating and extruding clay for application to a surface.

7. The device according to claim 6, wherein the clay is reduced in size, chipped or pelletised.

8. The device according to claim 6, wherein the extruder compacts and/or removes air from the clay prior to extrusion.

9. The device according to claim 6, wherein the device is configured to apply the extruded clay onto a surface via a tube.

10. The device according to claim 9, wherein the device comprises pressure rollers that are configured to press the clay onto a surface during application.
